(19) United States
(12) Patent Application Publication
(10) Pub. No.: US 2008/0154533 A1
(43) Pub. Date: Jun. 26, 2008

(54) APPARATUS, COMPUTER-READABLE MEDIUM, AND METHOD FOR CALIBRATING AN INPUT MECHANISM

(75) Inventor: Knud Poulsen, Hvidovre (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/614,312

(22) Filed: Dec. 21, 2006

(51) Int. Cl. G01D 1/16

(52) U.S. Cl. 702/127

(57) ABSTRACT

Embodiments of the present invention provide an apparatus, a computer-readable medium, and a method for calibrating an input mechanism. For example, the apparatus includes an input mechanism configured to receive user input and at least one sensor configured to measure at least one excursion value of the input mechanism in at least one associated direction in response to user input. The apparatus also includes a processor configured to communicate with the input mechanism and the at least one sensor. The processor is further configured to automatically calibrate a current maximum excursion value of the input mechanism based on the at least one measured excursion value and a predetermined calibration standard.

### BACKGROUND OF THE INVENTION

1) Field of the Invention

Embodiments of the present invention relate to input mechanisms and, more particularly, to input mechanisms used with mobile terminals, as well as an associated method for calibrating the input mechanism.

2) Description of Related Art

Electronic devices, such as mobile terminals, computers, and gaming terminals, may include a variety of input devices that allow a user to provide various commands for controlling the electronic device. For example, the electronic device may include a joystick that could be used to scroll a user interface (UI) or move a cursor through a menu on a phone and select an item from the menu.

Some input devices may require gain calibration in order to achieve a consistent usability experience for the user and among many electronic devices. Calibration may be required where the electronic device is stepped on, dropped, or otherwise deformed. For example, mechanical tolerances in production of capacitively coupled analog joystick-type sensors can be used to establish individual gain calibration of the devices' output signal. Factory calibration is, however, an expensive exercise and has to be repeated if the electronic device is stepped on (thereby changing mechanical tolerances) or the joystick-type sensor is replaced in after-market repair.

A substantial usability problem occurs if the joystick's maximum excursion or tuning value in any direction is set too low such that a very slight movement in that direction will cause the UI to react very sensitively in that direction, quickly maximizing repeat speed and causing the UI to move sporadically. If on the other hand, the maximum excursion value is set too high, a significant force will have to be applied to the joystick to cause the UI to scroll very slowly.

Therefore, there is a need for a joystick that is capable of being calibrated in an efficient and inexpensive manner. In addition, there is a need for a joystick that is capable of being calibrated without significantly interfering with the end-user experience.

### BRIEF SUMMARY OF THE INVENTION

Embodiments of the invention address the above needs and achieve other advantages by providing an apparatus, a computer-readable medium, and a method for calibrating an input mechanism. The apparatus includes a processor that measures maximum excursion values in one or more respective directions and calibrates the input mechanism based on the measured values. In addition, the processor may utilize a shrinkage algorithm as an additional factor in automatically calibrating the input mechanism for potentially increasing long-term reliability.

According to one embodiment, an apparatus includes an input mechanism (e.g., a joystick) configured to receive user input and at least one sensor (e.g., a capacitive force sensor) configured to measure at least one excursion value of the input mechanism in at least one associated direction in response to user input. The apparatus also includes a processor configured to communicate with the input mechanism and the at least one sensor. The processor is further configured to automatically calibrate a current maximum excursion value of the input mechanism based on the at least one measured excursion value and a predetermined calibration standard.

According to additional aspect of the present invention, the apparatus may include a memory configured to store the measured excursion value and/or the current maximum excursion value in at least one associated direction. The sensor may be configured to measure a plurality of associated excursion values, such as along a pair of substantially orthogonal axes. Furthermore, the predetermined calibration standard may include a predetermined decrement of the current maximum excursion value. For example, the processor could include a shrinkage algorithm for automatically decrementing the current maximum excursion value in predetermined increments of time. The apparatus could further include a decoder configured to convert signals detected by the at least one sensor that are indicative of the at least one measured excursion value for processing by the processor.

A further aspect of the present invention provides an associated computer-readable medium and method for calibrating an input mechanism. For example, the method includes measuring at least one excursion value of an input mechanism in at least one associated direction in response to user input. The method also includes automatically calibrating a current maximum excursion value of the input mechanism based on the at least one measured excursion value and a predetermined calibration standard.

Aspects of the method include automatically calibrating based on the predetermined calibration standard by decrementing the current maximum excursion value in predetermined increments of time. Automatically calibrating may include increasing or decreasing the current maximum excursion value. Moreover, the automatic calibration may occur in real time. The method may further include storing the measured excursion value and/or a current maximum excursion value in at least one associated direction. In addition, the method may further include calculating a percent position of the input mechanism in the at least one associated direction based on the at least one excursion value measured by the at least one sensor and the current maximum excursion value.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram illustrating a mobile terminal in communication with a base station, according to one embodiment of the present invention;

FIG. 2 is a schematic block diagram of a mobile terminal according to one embodiment of the present invention;

FIG. 3 is a plan view of a mobile terminal including an input mechanism according to one embodiment of the present invention;

FIG. 4 is a flowchart illustrating various steps of a method for calibrating an input mechanism according to one embodiment of the present invention;

FIGS. 4A-C illustrate exemplary code for running algorithms for calibrating an input mechanism according to an embodiment of the present invention;

FIGS. 5 and 5A are diagrams illustrating excursion values for an input mechanism according to one embodiment of the present invention; and

FIG. 6A-C and 7A-B are diagrams of original and calibrated maximum excursion values according to an embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

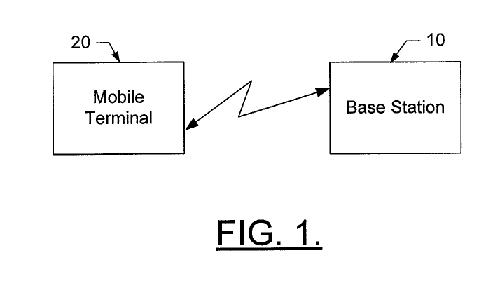

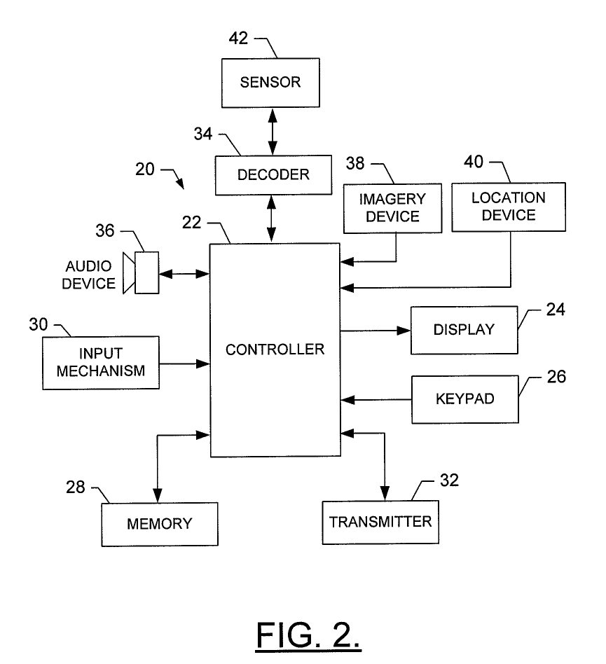

Referring now to the drawings and, in particular to FIG. 1, there is shown a mobile terminal 20 in communication with a base station 10. One suitable mobile terminal 20 is illustrated by a block diagram of FIG. 2. It should be understood, that the terminal illustrated and hereinafter described is merely illustrative of one type of terminal that would benefit from embodiments of the present invention and, therefore, should not be taken to limit the scope of the present invention. As such, “mobile terminal” is not meant to be limiting and could include other types of hand held and communication devices, such as mobile telephones, portable digital assistants (PDAs), pagers, laptop computers, and other types of voice and text communications systems, which can readily employ the present invention. Furthermore, while several embodiments of the present invention include a mobile terminal 20, the terminal need not be mobile. Similarly, the system and method of embodiments of the present invention will be primarily described in conjunction with mobile communications applications. It should be understood, however, that the system and method of the present invention can be utilized in conjunction with a variety of other applications, both in the mobile communications industries and outside of the mobile communications industries.

As shown in FIG. 2, the mobile terminal 20 includes a processor such as a controller 22. The controller 22 includes the circuitry required for implementing the functions of the mobile terminal 20 in accordance with embodiments of the present invention, as explained in greater detail below. For example, the controller 22 may be comprised of a digital signal processor device, a microprocessor device, and/or various analog to digital converters, digital to analog converters, and other support circuits. The control and signal processing functions of the mobile terminal 20 are allocated between these devices according to their respective capabilities. The controller 22 provides means for communicating with various components of the mobile terminal 20, such as an input mechanism 30 and a sensor 42. For instance, at least a portion of the controller 22 may be embodied in a hardware driver as a component of a keyboard server of the mobile terminal 20 that is capable of calibrating an input mechanism 30, as explained in further detail below. The controller 22 may also include the functionality to operate one or more software applications. For example, the controller 22 may be capable of operating a connectivity program, such as a conventional Web browser. The mobile terminal 20 may further include a battery, such as a vibrating battery pack, for powering various circuits that are required to operate the mobile terminal 20.

In addition to the controller 22, the mobile terminal 20 includes an interface that may include, for example, an audio device 36 having a microphone and conventional earphone or speaker capable of being driven by the controller to present various audible tones during operation of the terminal. The interface may also include a display 24 and an input interface, both of which are also coupled to the controller. The input interface, which allows the terminal to receive data, can comprise any of a number of devices allowing the terminal to receive data, such as a keypad 26, an input mechanism 30 (discussed below), a touch display (not shown) or other input device. In embodiments including a keypad 26, the keypad can include one or more keys used for operating the mobile terminal.

The mobile terminal 20 also includes a transmitter 32 that is able to transmit messages and information when an appropriate signal is established between the transmitter and a receiver, such as with a cellular transmitter and receiver. Thus, the transmitter 32 could include an antenna for transmitting signals to, and for receiving signals from, a base site or base station 10. The signals include signaling information in accordance with the air interface standard of the applicable cellular system, and also user speech and/or user generated data. In this regard, the mobile terminal 20 is capable of operating with one or more air interface standards, communication protocols, modulation types, and access types. By way of illustration, the mobile terminal 20 is capable of operating in accordance with any of a number of first, second and/or third-generation communication protocols or the like. For example, the mobile terminal 20 may be capable of operating in accordance with second-generation (2G) wireless communication protocols IS-136 (TDMA), GSM, and IS-95 (CDMA). While the mobile terminal 20 will be described as having a cellular transmitter, the mobile terminal can have any other type of wireless transmitter.

The base station 10 is a part of a cellular network that includes a mobile switching center (MSC), a message center, voice coder/decoders, data modems, and other units required to operate the network. The MSC is capable of routing calls and messages to and from the mobile terminal 20 when the mobile terminal is making and receiving messages and/or information. The MSC controls the forwarding of messages to and from the base station when the station is registered with the network. Such messages may include, for example, voice messages received by the MSC from users of Public Switched Telephone Network (PSTN) telephones, and may also include Short Message Service (SMS) messages, Multimedia Messaging Service (MMS) messages, and voice messages received by the MSC from the mobile terminal or other mobile terminals serviced by the network.

The mobile terminal 20 includes a memory 28 that may be volatile or non-volatile, as well as dedicated or assignable. The non-volatile memory, for example, may comprise embedded or removable multimedia memory cards (MMC's), Memory Sticks manufactured by Sony Corporation, EEPROM, flash memory, hard disk or the like. The memory can store any number of pieces of information, and data, used by the mobile terminal 20 to implement the functions of the terminal. For example, the memory 28 stores Personal Identification Numbers (PIN's) that may be used to activate and deactivate the transmitter 32 by entering the PIN's with the keypad 26.

The memory 20 is also able to store information recorded by one or more devices. The information could be collected from audio 36, imagery 38, and location 40 devices. In this regard, the audio device 36, as described above, typically includes a speaker and microphone that is able to send and receive audible tones. The imagery device 38 could be any device capable of recording an image, such as a digital camera for capturing a photograph or video. Furthermore, the location device 40 is generally a global positioning system (GPS) receiver but could be any suitable device for providing a location of the mobile terminal 20.

The mobile terminal 20 also includes means for receiving user input, such as with an input mechanism 30. According to one embodiment, the input mechanism 30 is a joystick configured to be manipulated by a user. In another embodiment, the input mechanism 30 is a touchpad to which a user can apply pressure and move his or her finger along to indicate a direction of motion. A sensor 42 may receive signals indicative of the excursion values of the input mechanism 30, as explained in further detail below. The user typically uses the input mechanism 30 to control or navigate a user interface (UI), cursor, or the like on the display of the mobile terminal 20. For example, the input mechanism 30 could be used to scroll through a menu and select an item within the menu. The input mechanism 30 is capable of moving in at least four directions along x- and y-axes. For example, the input mechanism 30 could move a UI up, down, left, and right.

It is understood that the input mechanism 30 is not limited to a joystick for manipulation along an x- and y-axis. In particular, additional aspects of the present invention provide an input mechanism 30 that includes any device that may be manipulated by a user in one or more directions and degrees of freedom. For example, the input mechanism 30 could be a device that may be grasped by the user and moved in one or more directions, such as that disclosed in U.S. Pat. No. 7,123,240 to Kemppinen, entitled MOBILE TERMINAL WITH JOYSTICK, which is incorporated herein by reference.

As indicated above, the mobile terminal 20 includes a sensor 42 that is utilized as means to measure excursion values of the input mechanism 30. According to one aspect of the present invention, the sensor 42 is capable of measuring a respective excursion value along each of the axes that the input mechanism 30 is capable of moving. As used herein, the excursion value is the position of the input mechanism 30 in a particular direction. The excursion value is located with a range of values, such as between a zero or default position and a maximum possible position allowed by the input mechanism 30, although in alternative embodiments the excursion value may be a positive or negative value such that the excursion value is between a maximum negative value and a maximum positive value. For example, the sensor 42 may measure a pair of excursion values along the x-axis (e.g., left and right) and a pair of excursion values along a y-axis (e.g., top and bottom). According to one exemplary embodiment, the sensor 42 may be a capacitive force sensor such as that manufactured by Sunarrow Limited (Japan). For an analog sensor 42, a decoder 34 is typically employed to convert the signals indicative of the excursion values detected by the sensor into signals that may be processed by the controller 22. For example, pressing down on the input mechanism 30 located proximate the sensor 42 generates an electric capacity change, which may be measured and converted to a voltage change. The gain in pressing force can be converted to speed and position change to determine the excursion value.

It is also understood that the above-described description of the sensor 42 is not meant to be limiting, as the sensor may be any suitable sensor for measuring at least one excursion value of the input mechanism 30 in at least one associated direction. For example, the sensor 42 could be an encoder, analog sensor, digital sensor, or other suitable device for measuring an excursion value of the input mechanism 30. The sensor 42 could also measure excursion values of the input mechanism 30 in a plurality of degrees of freedom and directions, such as along one or more orthogonal axes, and there may be one or more sensors for measuring the one or more excursion values. For instance, if a user manipulates the input mechanism 30 such that the UI moves at an oblique angle to the x- and y-axes, the sensor 42 may measure an excursion value along both the x- and y-axes that corresponds to the position of the UI.

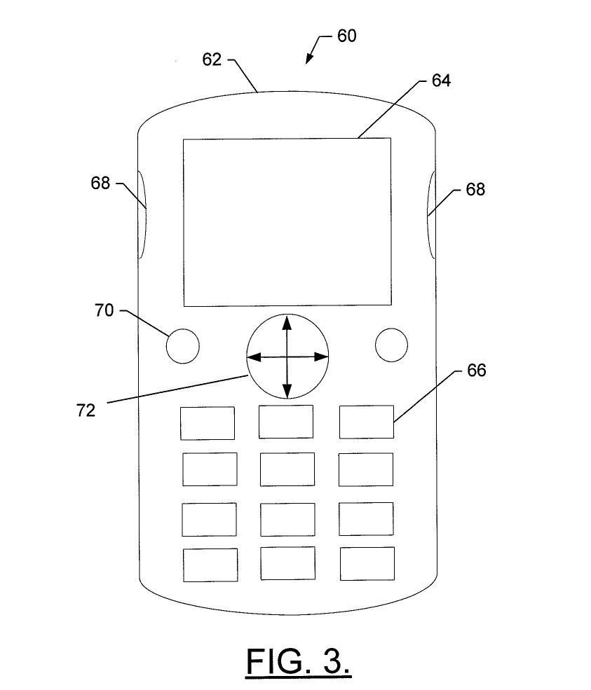

As indicated above, and shown in FIG. 3, the mobile terminal 20 of one embodiment of the present invention is capable of being embodied in a mobile phone 60 or other suitable portable package. The mobile phone 60 is fully functional to send and receive calls, check and receive voicemail, and perform any other function of a mobile or cellular phone as known to those skilled in the art. The mobile phone 60 includes a housing 62, as well as a display 64 and a keypad 66. The keypad 66 typically includes standard numeric keys and any number of additional soft keys 68 and 70 that may have various functions. The mobile phone 60 also includes an input mechanism 72 that is used to manipulate a UI on the display 64, such as to select an item from a list in a menu. The illustrated exemplary input mechanism 72 is generally circular in configuration such that a user may apply pressure and move his or her finger in one or more directions to move the UI on the display 64.

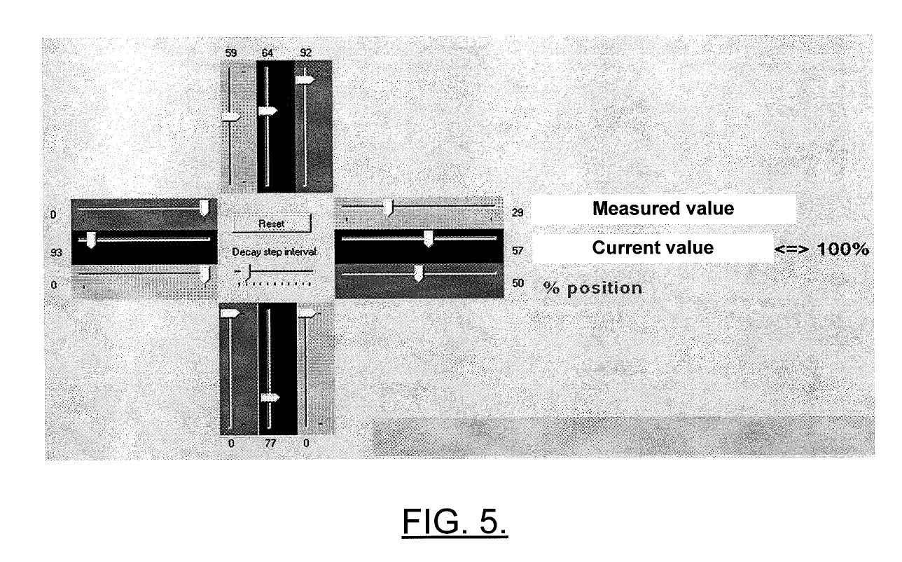

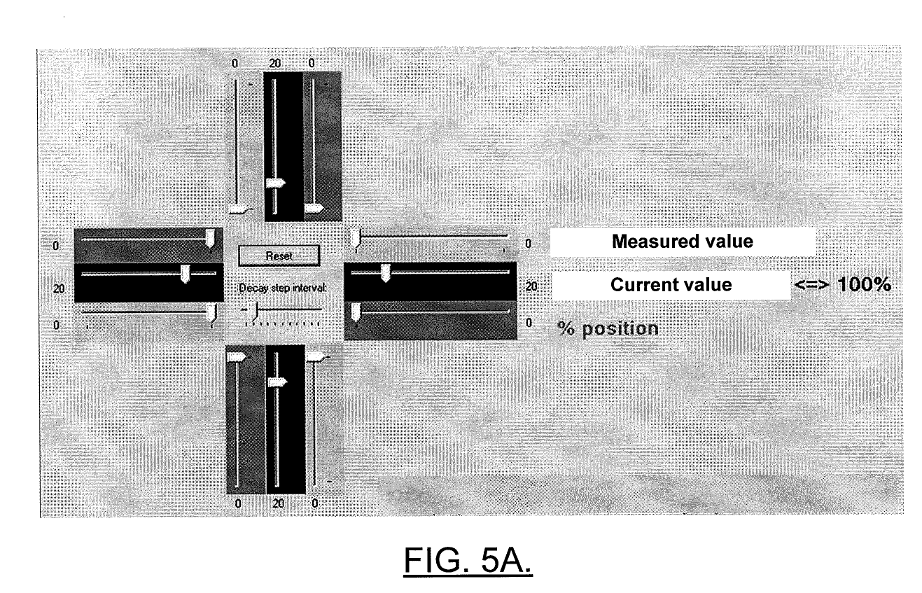

Off of the production line, the mobile terminal 20 generally includes a default maximum excursion value. The default maximum excursion value is typically an excursion value greater than 0% (as a 0% maximum excursion value is infinitely responsive) of the absolute maximum excursion value as dictated by the mechanical tolerances and other design constraints of the input mechanism 30. For example, FIG. 5A illustrates that the default maximum excursion value could be calibrated to be 20% of the absolute maximum excursion value, as determined from a representative reference sensor. The calibration process described below may include maintaining the current maximum excursion value equal to or greater than the default maximum excursion value. Thus, the current maximum excursion value may increase from the default maximum excursion value but will not fall below the default maximum excursion value.

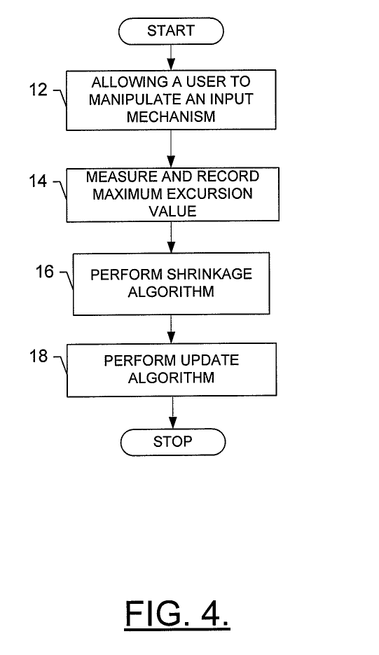

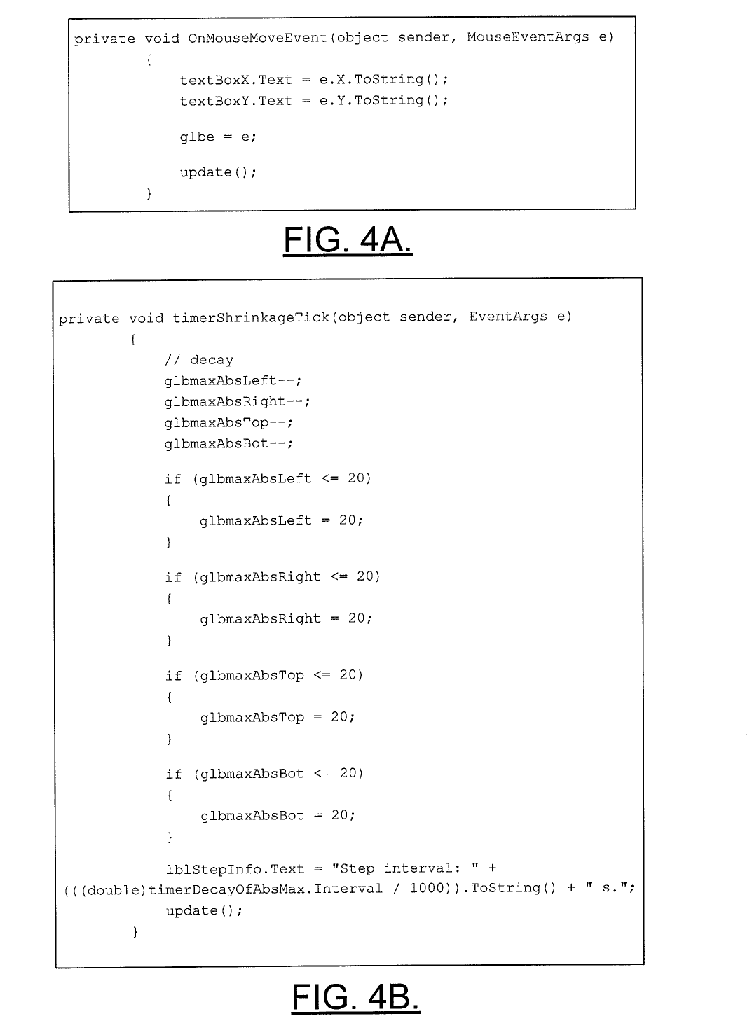

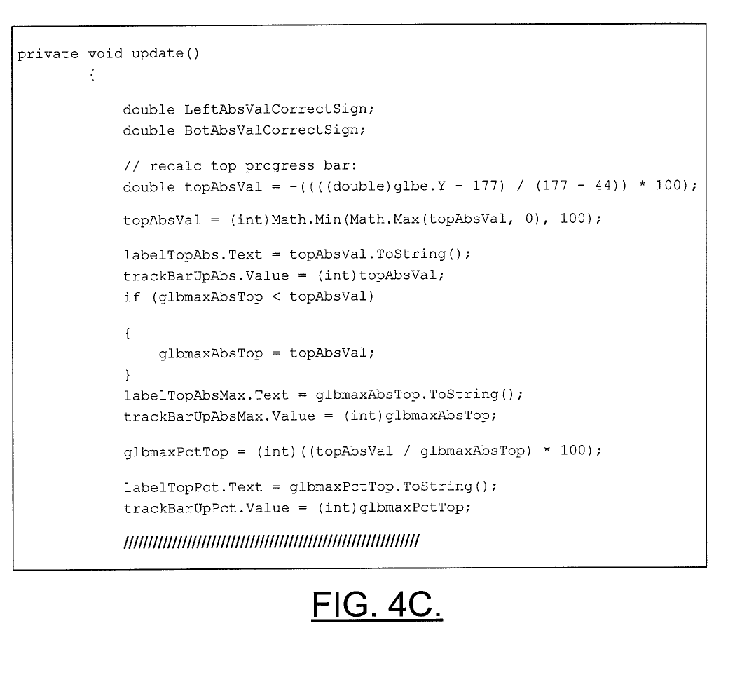

As shown in FIG. 4, one exemplary embodiment of the invention for calibrating an input mechanism 30 is shown. The calibration process of FIG. 4 may begin when the user first uses the phone. The calibration process may be automatically performed in real time as the user uses the input mechanism 30, as will be explained in further detail below. Thus, the calibration process provides customized control of an input mechanism 30 based on a user's habits for manipulating the input mechanism, as well as the age of the input mechanism. The calibration process not only takes into account the excursion values but also the sensitivity at which the UI reacts in response to user input. In this regard, altering the current maximum excursion value results in a corresponding change in sensitivity of the input mechanism 30. In particular, the current maximum excursion value and sensitivity are linearly related such that calibration of the current maximum excursion value results in an associated calibration of the sensitivity of the input mechanism 30.

In general, the current maximum excursion value is calibrated based on user input and a predetermined calibration standard. The calibration process generally includes allowing a user to manipulate an input mechanism 30 (block 12) such as by applying pressure on the input mechanism and in one or more directions in order to move a UI displayed on the mobile terminal 20. The process also includes measuring and recording an excursion value in at least one associated direction (block 14) resulting from the manipulation of the input mechanism 30. As shown in FIG. 4A, exemplary code for storing the position of the UI is shown, wherein X and Y excursion values along respective x- and y-axes and are stored as “glbe” (i.e., global e) in memory 28, where “e” corresponds to an event or position.

A predetermined calibration standard is used to calibrate the input mechanism 30. According to one aspect of the present invention, the predetermined calibration standard is defined by a shrinkage algorithm that is executed by the controller for automatically calibrating the input mechanism 30 (block 16). The shrinkage algorithm may be necessary due to mechanical deformation (e.g., stepping on or dropping the mobile terminal 20) or repair of the sensor 42. The shrinkage algorithm utilizes a decay step interval or timer to automatically decrement the current maximum excursion value. For example, the shrinkage algorithm may decrement the current maximum excursion value by a predetermined value (e.g., 1% of the current maximum excursion value) in accordance with a predefined schedule, such as defined by the decay step interval or timer (e.g., every two hours). Decreasing the current maximum excursion value results in a more sensitive response of the input mechanism 30 because the new current maximum excursion value is lower, which results in more sensitive movement in that direction, as the distance to 100% relative excursion is shorter. FIG. 4B depicts exemplary code for performing a shrinkage algorithm according to one aspect of the present invention. In this regard, FIG. 4B demonstrates that a current maximum excursion value may be set to 20 (e.g., 20% of the absolute maximum excursion value) for left, right, top, and bottom directions. The current maximum excursion value may be decremented by a predetermined value (e.g., glbmaxAbsLeft—or glbmaxAbsLeft=glbmaxAbsLeft−1) in predetermined time intervals (e.g., as a timer).

The calibration process also includes performing an update algorithm (block 18). The update algorithm is used to calibrate the input mechanism 30 based on the recently measured excursion value. The update algorithm may be executed by the controller concurrently with execution of the shrinkage algorithm, and the update algorithm may run in real time as the user uses the input mechanism 30. However, the update algorithm could be performed periodically, rather than in real time, in order to calibrate the current maximum excursion value. Referring to FIG. 4C, exemplary code for performing the update algorithm is shown according to one aspect of the present invention. FIG. 4C corresponds to calibration of a “top” axis, where similar code will be used for each of the remaining axes (e.g., left, right, and bottom directions). The “topAbsVal” command indicates that the range of the excursion value along the top axis is between 0 and 100. The command “if (glbmaxAbsTop<topAbsVal)” and “glbmaxAbsTop=topAbsVal” indicates that if the measured excursion value (i.e., “topAbsVal”) is greater than the current maximum excursion value (i.e., “glbmaxAbsTop”), then the measured excursion value becomes the new current maximum excursion value. The relative position of the UI in the top direction may be presented as a percentage using the command “glbmaxPctTop=(int)((topAbsVal/glbmaxAbsTop)*100). For instance, a relative position of the UI of 80% would result from the measured current maximum value being located at a position of 80% of the current maximum excursion value. FIG. 4C also includes commands (e.g., “labelTopPct.Text” and “trackBarUpPct.Value”) that relate to optional printouts and visualization of a track bar indicating the maximum excursion values, such as shown in FIGS. 5 and 5A, as well as storing the current maximum excursion value before subsequently recalibrating the maximum excursion value. For example, the current maximum excursion value is stored (e.g., if (glbmaxAbsTop<topAbsVal){glbmaxAbsTop=topAbsVal;}) based on the measured excursion value, and the range of the excursion value is calculated (e.g., double topAbsVal−(((double)glbe.Y−177)/(177−44))*100); top AbsVal=(int)Math.Min(Math.Max (topAbsVal, 0), 100)).

FIGS. 5-7 illustrate exemplary diagrams of excursion values for an input mechanism 30. In this regard, FIG. 5 illustrates maximum excursion values along x- and y-axes (e.g., left, right, top, and bottom directions) measured as percentages, while FIG. 5A shows exemplary default maximum excursion values (e.g., 20%) along each axis. For instance, along the positive x-axis, a measured maximum excursion value is currently at about 29%, and the current absolute maximum excursion value is about 57% of the full range of the input mechanism, i.e., the absolute maximum excursion value. Thus, the measured maximum excursion value is at a position of about 50% of the current maximum excursion value. Similarly, the measured maximum excursion value along the positive y-axis is about 59%, while the current maximum excursion value is set at about 64%, such that the measured maximum excursion value is at a position of about 92% of the current maximum excursion value. As described above, a user need not necessarily move the input mechanism along the x-and y-axes in order to measure an excursion value, as moving the input mechanism in a direction between axes (i.e., movement with both x and y components) will result in measuring excursion values along both axes. For example, moving the input mechanism 30 in any particular direction within a quadrant defined by the positive x- and y-axes will result in measuring an excursion value along both the x- and y-axes. Furthermore, FIG. 5 depicts that a decay step interval is employed and set to a desired time interval. The decay step interval may be set at any predetermined decrement of the current maximum excursion value that occurs in predetermined increments of time. For example, the decay step interval could be set to decrement the current maximum excursion value every one or two hours.

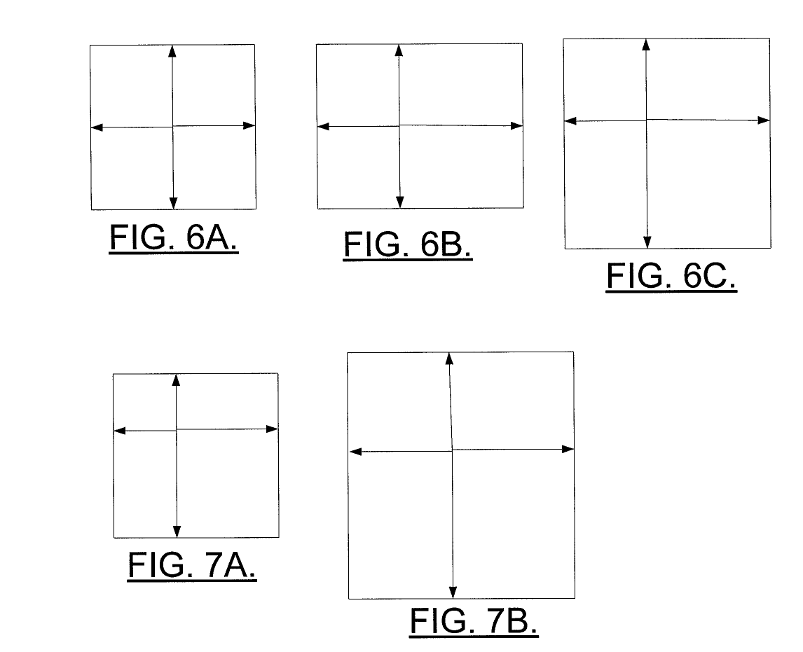

FIG. 6A shows an example of an initial setting for the current maximum excursion values, while FIG. 6B shows a current maximum excursion value that has been calibrated along the positive x-axis (e.g., right direction). The current maximum excursion value has increased along the positive axis in FIG. 6B as a result of a measured maximum excursion value that exceeded the current maximum excursion value in the x-direction. Similarly, FIG. 6C shows the current maximum excursion values along the negative y-axis (e.g., bottom direction) has been increased, which signifies that the measured maximum excursion value the y-direction exceeded the current maximum excursion value and caused the current maximum excursion value to be reset in the y-direction. Furthermore, FIG. 7A illustrates a shrinkage aspect, wherein the current maximum excursion values along the x- and y-axes may be reduced from that shown in FIG. 6C using the predetermined calibration standard described above. FIG. 7B shows new current maximum excursion values that have been recalibrated in all four directions when the measured excursion values are greater than the current maximum excursion values.

FIG. 4 is a flowchart of a system, methods, and program products according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Embodiments of the present invention may provide several advantages. For example, the calibration algorithm proposed herein may automate the calibration process as a background runtime task, which does not interfere noticeably with the end-user experience. In addition, embodiments of the present invention may provide real-time and automated calibration of the input mechanism such that factory calibration is unnecessary. Thus, the long-term reliability of the input mechanism may be increased, which may provide for a more satisfactory end-user experience.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
an input mechanism configured to receive user input;
at least one sensor configured to measure at least one excursion value of the input mechanism in at least one associated direction in response to user input; and
a processor configured to communicate with the input mechanism and the at least one sensor, the processor further configured to automatically calibrate a current maximum excursion value of the input mechanism based on the at least one measured excursion value and a predetermined calibration standard.

2. The apparatus of claim 1, further comprising a memory configured to store at least one of the measured excursion value and the current maximum excursion value in at least one associated direction.

3. The apparatus of claim 1, wherein the at least one sensor is configured to measure a plurality of associated excursion values.

4. The apparatus of claim 3, wherein the at least one sensor is configured to measure the plurality of associated excursion values along a pair of substantially orthogonal axes.

5. The apparatus of claim 1, wherein the predetermined calibration standard comprises a predetermined decrement of the current maximum excursion value.

6. The apparatus of claim 5, wherein the processor is configured to execute a shrinkage algorithm for automatically decrementing the current maximum excursion value in predetermined increments of time.

7. The apparatus of claim 1, wherein the at least one sensor comprises a capacitive force sensor.

8. The apparatus of claim 1, wherein the input mechanism comprises a joystick.

9. The apparatus of claim 1, further comprising a decoder configured to convert signals detected by the at least one sensor that are indicative of the at least one measured excursion value for processing by the processor.

10. A computer-readable medium containing instructions for controlling one or more processors to perform a method for calibrating an input mechanism comprising:
measuring at least one excursion value of an input mechanism in at least one associated direction in response to user input; and
automatically calibrating a current maximum excursion value of the input mechanism based on the at least one measured excursion value and a predetermined calibration standard.

11. The computer-readable medium of claim 10, wherein automatically calibrating based on the predetermined calibration standard comprises automatically decrementing the current maximum excursion value in predetermined increments of time.

12. The computer-readable medium of claim 10, wherein automatically calibrating comprises increasing or decreasing the current maximum excursion value.

13. The computer-readable medium of claim 10, further comprising storing at least one of the measured excursion value and a current maximum excursion value in at least one associated direction.

14. The computer-readable medium of claim 10, wherein automatically calibrating comprises automatically calibrating the current maximum excursion value in real time.

15. The computer-readable medium of claim 10, further comprising calculating a percent position of the input mechanism in the at least one associated direction based on the at least one excursion value measured by the at least one sensor and the current maximum excursion value.

16. A method for calibrating an input mechanism comprising:
measuring at least one excursion value of an input mechanism in at least one associated direction in response to user input; and
automatically calibrating a current maximum excursion value of the input mechanism based on the at least one measured excursion value and a predetermined calibration standard.

17. The method of claim 16, wherein automatically calibrating based on the predetermined calibration standard comprises automatically decrementing the current maximum excursion value in predetermined increments of time.

18. The method of claim 16, wherein automatically calibrating comprises increasing or decreasing the current maximum excursion value.

19. The method of claim 16, further comprising storing at least one of the measured excursion value and a current maximum excursion value in at least one associated direction.

20. The method of claim 16, wherein automatically calibrating comprises automatically calibrating the current maximum excursion value in real time.

21. The method of claim 16, further comprising calculating a percent position of the input mechanism in the at least one associated direction based on the at least one excursion value measured by the at least one sensor and the current maximum excursion value.

22. An apparatus comprising:
means for receiving user input;
means for measuring at least one excursion value of said input means in at least one associated direction in response to user input; and
means for communicating with said input means and said measuring means, said communication means further configured to automatically calibrate a current maximum excursion value of said input means based on the at least one measured excursion value and a predetermined calibration standard.

23. The apparatus according to claim 22, wherein said means for communicating is further configured to execute a shrinkage algorithm for automatically decrementing the current maximum excursion value in predetermined increments of time based on the predetermined calibration standard.
